(19) United States
(12) Patent Application Publication
(10) Pub. No.: US 2017/0130096 A1
(43) Pub. Date: May 11, 2017

(54) AMPHIPHILIC SILOXANE MATERIALS TO REDUCE ADHESION EVENTS IN MEDICAL, MARINE AND INDUSTRIAL APPLICATIONS

(71) Applicant: The Texas A&M University System, College Station, TX (US)

(72) Inventors: Melissa A. Grunlan, College Station, TX (US); Ranjini Murthy, Eaton, PA (US)

(73) Assignee: The Texas A&M University System, College Station, TX (US)

(21) Appl. No.: 15/338,059

(22) Filed: Oct. 28, 2016

Related U.S. Application Data
(60) Provisional application No. 62/247,536, filed on Oct. 28, 2015.

(51) Int. Cl. C09D 183/12; C08G 77/18; C08G 65/336; C09D 5/16; C08G 77/46

(52) U.S. Cl. CPC C09D 183/12; C09D 5/1675; C08G 77/46; C08G 65/336; C08G 77/18

(57) ABSTRACT

In this disclosure, an amphiphilic siloxane may comprise a siloxane tether and polyethylene glycol.

### CROSS-REFERENCE TO RELATED APPLICATIONS

This application is a non-provisional application that claims the benefit of U.S. Application Ser. No. 62/247,536 filed on Oct. 28, 2015, which is incorporated by reference herein in its entirety.

### STATEMENT REGARDING FEDERALLY SPONSORED RESEARCH OR DEVELOPMENT

Not applicable.

### BACKGROUND OF THE DISCLOSURE

Field of the Disclosure

This disclosure may relate to the field of amphiphilic siloxane additives, and more specifically to compositions and methods related to amphiphilic siloxane additives that may be used to form different types of coatings that resist the adhesion of biological substances (e.g., proteins, cells, microorganisms, organisms) and other substances (e.g., dirt and ice).

Background of the Disclosure

Polymers such as silicones, polyurethanes, polyethylene, polypropylene, poly(ethylene terephthalate), and many others have been utilized in medical, marine and industrial applications because of their mechanical properties and processability. Unfortunately, the surfaces of these and other polymers as well as non-polymer surfaces may be highly prone to biofouling, bioadhesion, and adhesion processes. Biofouling may occur in many forms, including the adhesion of blood proteins, tear proteins, bacteria, and marine organisms. Biofouling as well as the adhesion of dirt, ice, and other substances may lead to reduced performance on a variety of surfaces.

Blood-contacting, ophthalmic, and tissue-contacting devices may be prone to biofouling. For instance, on the surfaces of blood-contacting intra- and extracorporeal devices, the adsorption of plasma proteins may often result in platelet adhesion and eventually thrombus formation. This may compromise not only device efficacy but potentially safety. In addition, ophthalmic devices may be compromised by the adhesion of tear proteins and bacteria. The adhesion of proteins, cells, and bacteria to a device implanted in the tissue may lead to reduced biocompatibility as well as infection.

Submerged marine structures and vessels may be prone to biofouling. For instance, marine organisms may adhere to their surfaces by secretion of a bioadhesive. This event may be preceded or accompanied by the adsorption of bacteria. This may lead to the attachment and accumulation of the marine organisms. Marine biofouling increases fuel consumption and compromises structural integrity, mandating extensive and costly periodic cleaning.

Consequently, there is a need for improving the biofouling and fouling resistance of polymers for medical, marine, and industrial applications.

### BRIEF SUMMARY OF SOME OF THE PREFERRED EMBODIMENTS

These and other needs in the art may be addressed in one embodiment by an amphiphilic siloxane comprising a siloxane tether and a polyethylene glycol.

These and other needs in the art may be further addressed in an embodiment by a mixture comprising an amphiphilic siloxane blended with at least one polymer, a combination of polymers, or a polymer blend. The amphiphilic siloxane may comprise a silane moiety, a siloxane tether, and a polyethylene glycol. A silane moiety on a terminal end of an amphiphilic siloxane may be a silicon atom bound to three functional groups selected from the group consisting of: alkyl, phenyl, vinyl, allyl, alkoxy, acrylate, methacrylate, hydrogen, amine, carboxylic acid, epoxide, and any combinations thereof. The silane moiety may be cross-linkable. The amphiphilic siloxane may be added to a silicone composition. An average number of siloxane repeat units in the siloxane tether of the amphiphilic siloxane may be 3 through 30. An average number of poly(ethylene glycol) (PEG) repeat units in the amphiphilic siloxane may be 5 through 16. A mixture may comprise an amphiphilic siloxane blended with at least one polymer, a combination of polymers, or a polymer blend, wherein the amphiphilic siloxane may comprise: a silane moiety; a siloxane tether; and polyethylene glycol. Silane moiety may be a silicon atom bound to three functional groups selected from the group consisting of: alkyl, phenyl, vinyl, allyl, alkoxy, acrylate, methacrylate, hydrogen, amine, carboxylic acid, epoxide, and any combinations thereof. The silicon atom may be attached to the three functional groups and a fourth group may be a tether-PEG group. The silane moiety of the amphiphilic siloxane may undergo covalent bonding to a surface to provide an amphiphilic siloxane covalently bonded coating of the surface, and wherein the surface may be selected from the group consisting of: blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ship hulls, submerged structures, tubing, and combinations thereof. A surface may be a hydroxylated surface. The amphiphilic siloxane may be blended with the different polymer, combination of polymers, or polymer blend to form a coating applied to a structure or material or used to form a structure or material, and wherein the structure or material may be selected from the group consisting of: blood-contacting intracorporeal devices, blood-contacting extracorporeal devices, tissue-contacting intracorporeal devices, tissue-contacting extracorporeal devices, catheters, stents, mechanical heat components, heart leads, subcutaneously implanted sensors, blood oxygenator pumps, tubing, syringes, blood bags, ship hulls, submerged structures, tubing, and combinations thereof. The structure or material may be formed by extrusion or molding. The amphiphilic siloxane may cross-link with at least one of the different polymer, combination of polymers, or polymer blend. The amphiphilic siloxane may not crosslink with any different polymer, combination of polymers, or polymer blend. A method may comprise coating a surface with an amphiphilic siloxane blended with at least one polymer, a combination of polymers, or a polymer blend, wherein the amphiphilic siloxane may comprise a siloxane tether and polyethylene glycol.

In addition, these and other needs in the art may also be addressed by a method comprising coating a surface with an amphiphilic siloxane to form a coated surface. The amphiphilic siloxane may comprise a siloxane tether and polyethylene glycol.

The foregoing has outlined rather broadly the features and technical advantages of the present disclosure in order that the detailed description of the disclosure that follows may be better understood. Additional features and advantages of the disclosure will be described hereinafter that form the subject of the claims of the disclosure. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE DRAWINGS

For a detailed description of the preferred embodiments of the disclosure, reference will now be made to the accompanying drawings in which:

FIG. 1 illustrates an amphiphilic siloxane comprising a triethoxysilane moiety adjacent to a siloxane tether and a PEG polymer;

FIG. 2A illustrates the static contact angles (θ_{static}) of water droplets on unmodified silicone and silicones modified with amphiphilic siloxanes and a PEG-control in accordance with embodiments;

FIG. 2B illustrates the static contact angles (θ_{static}) of water droplets on unmodified silicone and silicones modified with amphiphilic siloxanes and a PEG-control after exposure to air for 1-30 days, in accordance with embodiments;

FIG. 3A illustrates the static contact angles (θ_{static}) of unmodified silicone and silicones modified with amphiphilic siloxanes, a siloxane-control and a PEG-control in accordance with embodiments;

FIG. 3B illustrates the static contact angles (θ_{static}) of unmodified silicone and silicones modified with amphiphilic siloxanes, a siloxane-control and a PEG-control after exposure to air for 1 day to 4 weeks days, in accordance with embodiments;

FIG. 4A illustrates an assessment of barnacle reattachment efficiency (%) for microscope slides coated with unmodified silicone and silicones modified with various amphiphilic siloxanes and PEG-controls versus other coating materials; and

FIG. 4B illustrates an evaluation of barnacle adhesion to microscope slides coated with unmodified silicone and silicones modified with amphiphilic siloxanes and PEG-controls versus other coating materials.

### DETAILED DESCRIPTION OF THE PREFERRED EMBODIMENTS

The embodiments may relate to amphiphilic siloxanes comprising a siloxane tether and a polymer, and more particularly to compositions and methods for using amphiphilic siloxane additives to form different types of coatings that may resist the adhesion of biological substances (e.g., proteins, cells, microorganisms, organisms) and other substances (e.g., dirt and ice).

An embodiment may comprise a siloxane tether arranged adjacent to a polymer. A “siloxane tether,” as used herein, may refer to a varying-length molecular chain comprising one or more repeating Si—O backbone units, with different pendant groups or pendant atoms (R1, R2) bonded to the Si atoms, where the siloxane tether may be represented generally by the symbol S and the formula [R1,R2](SiO)ₘ where R1 and R2 may be a hydrogen, a methyl, any alkyl group, a fluorine, a fluorocarbon group, an alkoxy group, an epoxy, a phenyl, or any combination thereof. In some embodiments, the pendant groups or pendant atoms (R1 and/or R2) bonded to each Si atom may not be identical to each other. The pendant groups or atoms may be bonded to the Si atoms for any desirable reason. For example, if R1 and/or R2 are fluorocarbons, the amphiphilic siloxane may be more compatible with fluorosilicones and may improve antifouling properties relative to an amphiphilic siloxane where R1 and/or R2 are hydrocarbons. If R1 and/or R2 are epoxide groups or longer hydrocarbons, the amphiphilic siloxane may be more compatible with epoxides and may improve antifouling properties relative to an amphiphilic siloxane where R1 and/or R2 are methyl groups. As another example, if R1 and/or R2 are phenyl groups, the amphiphilic siloxane may improve mechanical properties relative to an amphiphilic siloxane where R1 and/or R2 are hydrocarbons. When describing Sₘ, m may be any integer between 1 and 50 or more. In a specific embodiment, the average value of m may be 4, 13, 17, 24 or 30. In other embodiments, the average value of m may range from 3 through 30. Thus, the amphiphilic siloxanes may be represented generally as: where P may be a polymer and the average value of n may be any integer between 1 and 200 or more. In a specific embodiment, n may be 4, 8 or 16. In other embodiments, n may range from 5 through 16. It is to be understood that various groups, for example methylene (—CH₂—) groups, may be interposed between the siloxane tether and polymer elements in the general representation, and any charged or neutral atoms or group of atoms (i.e., a functional group) may comprise the end group of the Pₙ including neutral, charged, or zwitterionic groups or combinations thereof. It is to be understood that various non-functional groups, for example methylene (—CH₂—) groups, may be interposed between the polymer and end group elements. Without limitation by theory, it may be postulated that a siloxane tether of specific average length, for example, a length (m) of 17, 24 or 30 Si—O units or a length (m) ranging from 3 through 30 Si—O units may reduce the amount of the amphiphilic siloxane which may leach out of a coating (e.g., silicone) such as during exposure to an aqueous substance, which is discussed below. Further, amphiphilic siloxanes with the desired average length of siloxane tether (e.g., where m may be 17, 24 or 30 or may range from 3 through 30), may function in biofouling applications without a crosslinkable end-group, for example, a silane moiety located at a terminal end of the amphiphilic siloxane, as discussed below. Additionally, some amphiphilic siloxanes may be used with coordinated specific m and n average values, for example, where m may be 4, 13, 17, 24 or 30 or may range from 3 through 30, n may be 8 or 16, or may range from 5 through 16. In such examples, specific average values of m and n may produce a synergy that provides unexpected results over similar amphiphilic siloxanes that comprise m and n values as any random number in a defined range. These amphiphilic siloxanes with optimized values may reduce biofouling for an extended period of time, without the need for crosslinkable end groups and may be used at relatively lower concentrations.

In embodiments, the polymer element (i.e., P) may be any hydrophilic homopolymer or copolymer. In embodiments comprising a copolymer, the copolymer may be a block, random, or alternating copolymer. The polymer may be branched or linear as desired. An example of a suitable polymer may be poly(ethylene glycol) (“PEG”). PEG may be a neutral, hydrophilic polymer with resistance to protein adhesion. As discussed above, in embodiments, P may be a polymer and n may be any integer between 1 and 200 or more. In specific embodiments, n may be 8 or 16 or may range from 5 through 16. Without limitation by theory, PEG's protein resistance may have been attributed to its high water content, large excluded volume, steric repulsion, and its blockage of adsorption sites on the underlying surface. As used herein, PEG may refer to an oligomer or polymer of ethylene glycol or ethylene oxide, otherwise known as poly(ethylene oxide) (“PEO”) or polyoxyethylene (“POE”). Other examples of a polymer may be oligo- or poly-oxazoline, poly(vinyl alcohol) (“PVOH”), poly(acrylic acid), poly(N-vinylpyrrolidinone), polyacrylamide, poly(N-isopropylacrylamide), and other appreciably water-soluble polymer and/or their copolymers.

The polymer group may be bonded, directly or indirectly, to a terminal end of the siloxane tether and may also contain an end group of the general form —OX. Such embodiments may include a linear polymer or branched polymer. The amphiphilic siloxanes comprising a linear polymer may be represented by the general formula: Sₘ-block-[(OCH₂CH₂)ₙ—OX] for amphiphilic siloxanes comprising PEG. The amphiphilic siloxanes comprising a branched polymer may be represented by the general formula: Sₘ-block-[(OCH₂CH₂)ₙ—OX]ᵥ for amphiphilic siloxanes comprising PEG. The “block” refers to a block-like distribution of the monomeric units of both the siloxane tether and the polymer segment(s) as opposed to a random or alternating distribution. X may be hydrogen, CH₃, any alkyl group, or any other charged, zwitterionic, or neutral atom or group of atoms (i.e., a functional group). As discussed above, m may be any integer between 1 and 50 and n may be any integer between 1 and 200 and more. With regards to branched polymers v may be 2 or more. In embodiments, m and n may represent average values. In embodiments, it may be preferable to use a combination of amphiphilic siloxanes, wherein the average of m and n values of the combination reflect a desired amount or range.

In some embodiments, n may be 8 or 16 or may range from 5 through 16. In embodiments where n comprises 8 or 16, a lower concentration of the amphiphilic siloxanes may be used in order to form suitable hydrophilic surfaces and/or resist protein adsorption relative to amphiphilic siloxanes in which the value of n is not 8 or 16. For example an anti-biofouling composition comprising a polymer (e.g., silicone) and an amphiphilic siloxane may require a concentration of amphiphilic siloxane of less than 2 wt % in order to achieve the desired amount of protein resistance. In some embodiments, an amphiphilic siloxane comprising an n value of 8 or 16 may modify the surface of a polymer (e.g., silicone) such that the surface of the polymer is hydrophilic and may become more hydrophilic upon exposure to an aqueous environment. Without limitation by theory, it is believed that restructuring to form a hydrophilic surface contributes to the resistance of protein adsorption and other biofoulers on surfaces coated with a polymer modified by an amphiphilic siloxane.

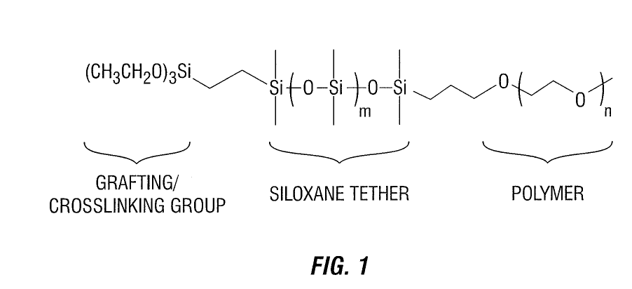

Optional embodiments of the amphiphilic siloxanes may comprise a silane moiety (represented by A, in the general formula A-Sₘ—Pₙ) arranged adjacent to the siloxane tether. The silane moiety may be a reactive crosslinkable/graftable silane moiety comprising the general formula, A=[R₃, R₄, R₅]Si where R₃, R₄, R₅ may be identical or not identical and may comprise up to two non-reactive groups. In some optional embodiments, the silane moiety may be located at a terminal end of the siloxane tether. R₃, R₄, R₅ may be hydrogen, any alkyl (e.g., CH₃CH₂, CH₃), a vinyl (CH₂═CH), an allyl (CH₂═CHCH₂), an acrylate (CH₂═CHCOO), derivatives of methacrylic acid, hydrogen, NH₂, amines (including primary, secondary, tertiary, and cyclic amines), carboxylic acid (COOH), and/or epoxy (including derivatives of the epoxide functional group). It is to be understood that various groups, for example methylene (—CH₂—) groups, may be interposed between the silane moiety and the siloxane tether in the general representation. In some optional embodiments, the intermediate groups separating the silane moiety from the siloxane group may not be restricted to methylene groups. Other functional groups may be suitable including alkenes, alkynes, ether, ester, etc. In the optional embodiments comprising the silane moiety, the amphiphilic siloxanes comprising a linear polymer may be represented by the general formula A-Sₘ-block-[(OCH₂CH₂)ₙ—OX] and the amphiphilic siloxanes comprising a branched polymer may be represented by the general formula A-Sₘ-block-[(OCH₂CH₂)ₙ—OX]ᵥ for amphiphilic siloxanes comprising PEG. An example is shown in FIG. 1, where an amphiphilic siloxane comprises a triethoxysilane moiety adjacent to a siloxane tether and a PEG polymer.

As discussed above, in optional embodiments, a charged or neutral atom or groups of atoms (i.e., a functional group) may comprise the end group of the Pₙ. These atoms may include neutral, charged, or zwitterionic groups. The appended atom or groups of atoms may be represented by B, in the general formula Sₘ—Pₙ—B and may be arranged adjacent to the polymer. In embodiments comprising the silane moiety, the general formula may be A-Sₘ—Pₙ—B. B may be a hydroxyl, alkoxy, hydrocarbon, quaternary ammonium salt, sulfobetaine, phosphobetaine, carboxybetain, amino acid, or combinations thereof. In some optional embodiments, B may be a tagging material such that the concentration of the amphiphilic siloxane in an application may be determined. For example, B may be a fluorescent tag which may be detectable in a coating formed from the amphiphilic siloxane.

Embodiments further comprise methods of synthesizing amphiphilic siloxanes with the optional silane moiety. An example embodiment may comprise regioselective hydrosilylation of (1) a compound containing an unsaturated bond and the desired silane moiety or moieties that may be present in the end product, and (2) an α,ω-bis(hydrosilyl) oligosiloxane or polysiloxane. This may result in a reaction at only one (or primarily at only one) of the two reactive hydrosilyl sites on the oligosiloxane or polysiloxane. In some embodiments, this reaction may be Rh-catalyzed; without limitation, the Rh-catalyzed reaction may be effected by the use of RhCl(Ph₃P)₃ catalyst (Wilkinson's catalyst) in the absence or in the presence of a solvent, such as toluene. It will be appreciated by one of ordinary skill in the art that any regioselective hydrosilylation mechanism may be used to attach the desired silane moiety to only one (or primarily to only one) terminal end of an oligosiloxane or polysiloxane. Likewise, the oligosiloxane or polysiloxane may contain any two terminal groups that will undergo a hydrosilylation reaction or its equivalent. Thus, the method of this embodiment may further comprise a second reactive step comprising the Pt-catalyzed hydrosilylation of the product of the first reactive step and a polymer bonded at one terminal end to a functional group capable of undergoing hydrosilylation (i.e., containing an unsaturated bond), such as, for example, oligo(ethylene oxide) allyl methyl ether. It should be appreciated that any catalyst enabling hydrosilylation or its equivalent may be used in the second reactive step. The synthesis may also be performed, for some compositions, in the reverse order of the method described above. An example embodiment may comprise regioselective hydrosilylation of (1) a polymer (e.g., PEG) bonded at one terminal end to a functional group capable of undergoing hydrosilylation (i.e., containing an unsaturated bond), such as, for example, oligo(ethylene oxide) allyl methyl ether and (2) an α,ω-bis(hydrosilyl) oligosiloxane or polysiloxane. This may result in a reaction at only one (or primarily at only one) of the two reactive hydrosilyl sites on the oligosiloxane or polysiloxane. In some embodiments, this reaction may be Rh-catalyzed; without limitation, the Rh-catalyzed reaction may be effected by the use of RhCl(Ph₃P)₃ catalyst (e.g., Wilkinson's catalyst) in the absence or in the presence of a solvent, such as toluene. It will be appreciated by one of ordinary skill in the art that any regioselective hydrosilylation mechanism may be used to attach the optional silane moiety to only one (or primarily to only one) terminal end of an oligosiloxane or polysiloxane. Likewise, the oligosiloxane or polysiloxane may contain any two terminal groups that will undergo a hydrosilylation reaction or its equivalent. Thus, the method of this embodiment may further comprise a second reactive step comprising the Pt-catalyzed hydrosilylation of the product of the first reactive step and a compound containing a functional group capable of undergoing hydrosilylation (i.e., containing an unsaturated bond), such as, for example allyl methacrylate or allyl acrylate. In either of the two embodiments, the terminal silane moiety or moieties may be chemically transformed into another functional group after the first or second reactive steps. For example, alkoxy silane groups may be transformed into vinyl silane groups via reaction with a vinyl Grignard reagent.

In embodiments, the amphiphilic siloxanes may be used in various manners as coatings or as components of coatings that resist the adhesion of proteins, cells, microorganisms and organisms, including marine biofoulers, and also non-biological substances. The amphiphilic siloxanes may be applied to any surface for which an increase in such resistances is desired. For example, these coatings may be applied to polymer and metallic blood- and/or tissue-contacting devices (both implanted and extracorporeal), such as catheters, hemodialysis catheters, stents, mechanical heart components, heart leads, subcutaneously implanted sensors, blood oxygenator pumps, tubing, syringes, blood bags, and the like; ophthalmic devices such as intraocular lenses and contact lenses; marine surfaces, such as ship hulls or other submerged or partially submerged structures; and membranes, e.g., for filtration and water treatment. Without limitation, submerged structures may include any such structure that is partially or fully submerged in water, of any size, shape, or material; manmade or otherwise. Without limitation, examples of which may include watercraft, submersibles, dams, cables, hydroelectric components, tubes, tubulars, offshore drilling derricks, offshore drilling rigs, docks, grates, vents, support columns, and the like. Additionally, the coatings may be utilized to increase surface hydrophilicity (i.e., wettability) for periods of time when stored in air, for example, when used for microfluidic devices. In embodiments, the amphiphilic siloxanes may be used to form a bulk coating on the surfaces of materials. The term “bulk coating” is used to distinguish it from “surface grafted coating” and may sometimes be referred to as “coating”. As an example, the process for forming a bulk coating may require blending (i.e., combining) the amphiphilic siloxanes and a polymer or polymer(s) before application as a coating, such that the amphiphilic siloxanes may be distributed throughout the resulting coating. Alternatively, the amphiphilic siloxanes and a polymer or polymer(s) may be blended (i.e., combined) and then formed (e.g., by extrusion, molding, etc.) into a structure or material, such that the amphiphilic siloxanes may be distributed throughout the structure. Alternatively, the amphiphilic siloxanes may be blended, mixed, combined or added in any way into a polymer, combination of polymers, and/or a polymer blend. As used herein, a polymer blend may be defined as a combination of two or more polymers. The distribution may be even or uneven depending upon the composition, conditions and/or desired application of the material. In further embodiments, the amphiphilic siloxanes may be added to a polymer (e.g., silicone) and stored until needed. Application of the combined amphiphilic siloxanes and polymer or polymers to materials (i.e., substrates) may comprise painting, casting, spraying or otherwise applying the materials. A solvent or solvent(s) or other additives may be included into the mixture of the amphiphilic siloxanes and polymer(s) to aid in the application process. Additives may also be incorporated to aid in the adhesion to the substrate, to enhance or diminish the extent or rate of crosslinking, to enhance or diminish viscosity, or to otherwise improve formation or application of the bulk coating or structure. The amphiphilic siloxanes and polymers may render the surface of a polymer (e.g., silicones) or polymer blends hydrophilic even upon exposure to air. Furthermore, the amphiphilic siloxanes and polymers may provide an anti-icing effect in addition to the previously described advantages of resistance to the adhesion of proteins, cells, microorganisms and organisms, including marine biofoulers. In embodiments, the anti-icing applications may be suitable for windmills, turbines, bladed components, and other similar surfaces that are at risk of icing.

Some embodiments may comprise a film or coating comprising a mixture of amphiphilic siloxanes blended with another polymer or polymer(s). The other polymer may be, as an example, silicone, fluorosilicone, polyurethane, or any other polymer. In embodiments, the amphiphilic siloxanes may be cross-linked with the other polymer. In embodiments, the amphiphilic siloxanes may not crosslink in part or in full with the other polymer or polymers. For example, the coating may comprise a mixture of amphiphilic siloxanes and an acetoxy-cure silicone containing 20% silica by weight, wherein the amphiphilic siloxanes molecules are cross-linked in part or in full with the acetoxy-cure silicone. The acetoxy-cure silicone may contain any other amount of silica or another or additional filler, and may alternatively be replaced by any other silicone. An example embodiment may comprise a coating comprising a mixture of amphiphilic siloxanes and an α,ω-bis(Si—OH)polydimethylsiloxane, wherein the amphiphilic siloxanes molecules may be cross-linked in part or in full with the α,ω-bis(Si—OH)polydimethylsiloxane. Furthermore, in embodiments, any other polymer or polymers besides a silicone may be used, depending upon the desired properties of the coating.

In some embodiments comprising polymers combined with amphiphilic siloxanes, the amphiphilic siloxanes may prevent hydrophobic recovery from occurring in the polymers. “Hydrophobic recovery” may generally refer to the surface restructuring of silicone or other polymer surface (e.g., such as when exposed to/maintained air) in which the surface has been modified to no longer be hydrophobic. For example, in some embodiments, an amphiphilic siloxane may prevent a surface modified polymer (e.g., silicone) from reversion to a hydrophobic state.

Embodiments additionally may comprise methods for crosslinking or partially crosslinking the amphiphilic siloxane(s) with the polymer(s) used to form the coating. This process may be accelerated or controlled by UV-light, heat, vacuum drying, moisture, catalysts or other additives. In some embodiments, cross-linking may be accomplished by, for example, the sol-gel crosslinking process between the other polymer or polymers and the optional silane moiety or moieties of the amphiphilic siloxanes. In these embodiments, the silane moiety of the amphiphilic siloxanes may comprise a hydrolysable silane moiety or moieties, or any other silane moiety or moieties able to undergo a sol-gel cross-linking reaction or reactions. In addition, other methods of cross-linking may alternatively be used. Further, in some embodiments, the method of making a coating comprising a cross-linked or partially cross-linked amphiphilic siloxane mixture may comprise cross-linking catalyzed by an acid catalyst. Thus, in one embodiment, the method may comprise combining an amphiphilic siloxane with an α,ω-bis(Si—OH)polydimethylsiloxane, and adding a solution of 3 mol (based on total solid weight of the resulting combination) H₃PO₄ (for example, a solution of H₃PO₄/EtOH at 10:90 w/w). Any other concentration may be used in the second step, as may any other acid, or any other catalyst that effects the desired combination of amphiphilic siloxanes with the α,ω-bis(Si—OH)polydimethylsiloxane. Furthermore, as with the above disclosed coatings, the method of making the coatings may use any other polymer or polymers in place of α,ω-bis(Si—OH)polydimethylsiloxane.

In embodiments, the method of preparing a coating comprising a cross-linked or partially cross-linked amphiphilic siloxane mixture may comprise mixing the amphiphilic siloxanes and other polymer or polymers in particular molar ratios. For example, in some embodiments, the method may comprise mixing amphiphilic siloxanes and another polymer in stoichiometrically balanced ratios. More specifically, in one embodiment, the amphiphilic siloxane may comprise a trialkoxysilane moiety, and the method may comprise mixing the amphiphilic siloxanes with α,ω-bis-(Si—OH)polydimethylsiloxane in a 2:3 molar ratio of amphiphilic siloxanes to α,ω-bis-(Si—OH)polydimethylsiloxane. Any other molar ratio may be used. As with the above method embodiments, other polymers instead of α,ω-bis-(Si—OH)polydimethylsiloxane may be used, and the amphiphilic siloxanes may comprise any other silane moiety capable of cross-linking with the other polymer.

Embodiments additionally comprise methods for preparing bulk coatings in the absence of crosslinking between amphiphilic siloxane(s) and polymer(s). In some embodiments, these methods may comprise blending (i.e., combining) the amphiphilic siloxanes with CARBOTHANE®. CARBOTHANE® is a registered trademark of the Lubrizol Corporation. In other embodiments, the method may comprise blending (i.e., combining) the amphiphilic siloxanes with any other polymer or polymers that do not undergo a cross-linking reaction (i.e. a thermoplastic). In yet other embodiments, the method may comprise blending (i.e., combining) the amphiphilic siloxanes with another polymer in the absence of a cross-linking catalyst. Any other conditions or chemicals that prevent cross-linking may be used to blend the amphiphilic siloxanes with another polymer to obtain the desired coating. Additives may also be incorporated to aid in the adhesion to the substrate, to enhance or diminish viscosity, or to otherwise improve formation or application of the bulk coating or structure.

Embodiments may further comprise a method of applying to various surfaces a mixture comprising amphiphilic siloxanes and another polymer, regardless of cross-linking. It will be appreciated that these mixtures may be applied to any surface for which it is desirable to reduce the adhesion of proteins, cells, microorganisms and organisms, including marine biofoulers, and also non-biological substances.

Embodiments may comprise coatings comprising amphiphilic siloxanes that may be grafted onto the surface of a polymer or metal to form a surface grafted coating. The term “surface grafted coating” may be used to distinguish it from “bulk coating” and in context may sometimes be referred to as “coating.” For example, the silane moiety of some optional embodiments of the amphiphilic siloxanes may be a functional silane (i.e., a coupling agent) able to be used for covalent grafting onto a surface.

Embodiments may further comprise various methods that may be used for grafting an amphiphilic siloxane to a surface via a functional silane moiety. For example, the functional silane moiety may be a trialkoxysilane that undergoes stepwise hydrolysis and condensation with a hydroxylated surface. This stepwise hydrolysis and condensation may be affected, for example, by exposing the hydroxylated surface to a solution comprising the amphiphilic siloxanes and toluene. The amphiphilic siloxanes may alternatively comprise any other silane moiety capable of being hydrolyzed, or any silane moiety capable of undergoing a cross-linking or covalent bonding reaction. In addition, any other method for effecting step-wise hydrolysis and condensation between the functional silane moiety and the hydroxylated surface may be used, as may any other method for cross-linking or for creating a covalent bond between the surface and the functional silane moiety. Surface grafting may be accelerated or controlled by UV-light, heat, vacuum drying, moisture, catalysts or other additives. Adhesion of the surface grafted coating to the substrate may be enhanced by use of additives (e.g., other silane coupling agents, adhesion promoters, etc.) or other reagents applied to the surface, introduced into a solution containing the amphiphilic siloxanes and a solvent, etc.

In some embodiments, a hydroxylated surface may be prepared by oxidation with an air or O₂ plasma treatment. A hydroxylated surface may also be prepared by any other means of oxidizing the surface. For example, a silicon wafer may be treated with concentrated H₂SO₄/30% H₂O₂ (Piranha) solution to create a hydroxylated surface. Any other method for creating a hydroxylated surface may be used. Furthermore, instead of a hydroxylated surface, any other surface capable of covalent bonding with a functional silane moiety may be used, or any other surface may be prepared to enable covalent bonding with a functional silane moiety. Some prepared surfaces, such as oxidized polymeric surfaces, and particularly oxidized silicones, may be physically unstable and reorganize in different environments (e.g., air and water). Thus, amphiphilic siloxanes grafted onto such hydroxylated polymer surfaces may undergo significant physical reorganization depending on the environment, which may subsequently alter the surface concentration of the amphiphilic siloxanes. Accordingly, in some embodiments, the hydroxylated surface may be subjected to surface grafting with the amphiphilic siloxanes immediately after hydroxylation. In other embodiments, the hydroxylated surface may be maintained in an aqueous environment until just prior to surface grafting.

Embodiments may further comprise methods to modify the surface concentration of the polymer element of the amphiphilic siloxane in coatings comprising an amphiphilic siloxane (whether grafted to a surface or mixed with another polymer or polymer(s)). For example, an amphiphilic siloxane coating may be exposed to an aqueous substance. An aqueous substance may, for example, be water-based (e.g., purified water, saline, buffer, tears, fresh water and ocean water) and may also contain other solvents, surfactants, catalysts, acids, bases, thickeners or other materials, including biological substances (e.g., proteins, cells, microorganisms and organisms). Alternatively, exposure may be to blood, including whole blood, plasma and platelet-enriched plasma. Exposure may be through various means, for example, by submersion in or rinsing with the aqueous substance for varying lengths of time. In general, longer exposure to the aqueous solution may correspond with greater surface concentration of the polymer (i.e., the polymer of the amphiphilic siloxanes, e.g., PEG) and/or greater hydrophilicity of the coating, which may assist in resistance to the adhesion of proteins, cells, microorganisms and organisms, including marine biofoulers, as well as other substances. In some embodiments, the coating may be exposed to an aqueous solution for 36 hours. In general, when the coating is first exposed to the aqueous substance, the surface concentration may increase with exposure time. Continued exposure to the aqueous substance for longer periods of time may further increase the surface concentration. Over longer exposure periods, this may result in a decrease in surface concentration relative to the minimum reached at an earlier time point during aqueous exposure.

Without limitation, other factors affecting the surface concentration of the polymer element of the amphiphilic siloxane may include: the type of surface onto which the amphiphilic siloxanes are grafted (or onto which an amphiphilic siloxane mixture is applied) and the structure of the amphiphilic siloxanes (e.g., whether the amphiphilic siloxanes comprises a branched or linear polymer). Accordingly, the methods disclosed herein may further comprise steps to take advantage of these properties in order to increase the surface concentration of the amphiphilic siloxanes.

Without limitation, a siloxane tether of a certain length (i.e., the “siloxaneₘ” or “Sₘ” may correspond to an S of a specific desirable length) may confer beneficial coating properties onto the amphiphilic siloxanes. For example, a siloxane tether of a desirable length may increase the surface concentration of the polymer chain when the amphiphilic siloxane is cross-linked in part or in full to another polymer to form a coating and/or when mixed/combined with a polymer without the occurrence of crosslinking. Similarly, a siloxane tether of a desirable length may increase the surface concentration of the polymer chain when the amphiphilic siloxane is grafted onto a surface. Further and without limitation, the presence of siloxane tethers of desirable lengths used to prepare coatings may enhance resistance to the adhesion of proteins, cells, microorganisms and organisms, including marine biofoulers, and also non-biological substances. Furthermore, such coatings may also exhibit greater hydrophilicity and therefore remain stable when submerged in an aqueous substance for a longer period of time relative to an m value that is not optimal for a specific application.

Accordingly, an embodiment may comprise an amphiphilic siloxane comprising a siloxane tether of 4, 13, 17, 24 or 30 Si—O backbone average number of units in length (i.e., “Sₘ” where the average value of m may be 4, 13, 17, 24 or 30), with different pendant groups or pendant atoms (R1, R2) bonded to the Si atoms, where R1 and/or R2 may be hydrogen, methyl, any alkyl group, fluorine, a fluorocarbon group, an alkoxy group, or a combination thereof. Other embodiments may comprise an amphiphilic siloxane comprising a siloxane tether with an Si—O backbone comprising an average number of units in length ranging from 3 through 30 (i.e., “Sₘ” where the average value of m may range from 3 through 30), with different pendant groups or pendant atoms (R1, R2) bonded to the Si atoms, where R1 and/or R2 may be hydrogen, methyl, any alkyl group, fluorine, a fluorocarbon group, an alkoxy group, or a combination thereof. The pendant groups or pendant atoms (R1, R2) bonded to each Si atom may be identical or not identical to each other. In some embodiments, the polymer (i.e., P) may include either linear or branched polymers as with previously discussed embodiments.

Further, a polymer of desirable length (i.e., the “polymerₙ” or “Pₙ” may correspond to a P of a specific desirable length) may be particularly useful in some anti-biofouling applications. For example, amphiphilic siloxanes comprising branched PEGs may exhibit greater resistance to adhesion of human fibrinogen (“HF”) protein. Accordingly, another embodiment may comprise an amphiphilic siloxane comprising a siloxane tether of 4, 13, 17, 24 or 30 Si—O backbone average number of units in length and a polymer comprising 8 or 16 ethylene oxide monomers (i.e., (OCH₂CH₂)ₙ, where the average value of n may be 8 or 16). Further, another embodiment may comprise an amphiphilic siloxane comprising a siloxane tether comprising a Si—O backbone with an average number of units in length ranging from 3 through 30, and a polymer comprising 5 through 16 ethylene oxide monomers (i.e., (OCH₂CH₂)ₙ, where the average value of n may range from 5 through 16).

In embodiments comprising a desirable value of m for Sₘ and n for Pₙ, the stability of the amphiphilic siloxane may be optimal such that A, the optional silane moiety which may be arranged adjacent to S, may not be necessary, which is to say that the crosslinkability and graftability functionalization bestowed by the silane moiety may not be required to maintain the amphiphilic siloxane within the coating (i.e., in the bulk and/or at the surface of the coating). Thusly, an amphiphilic siloxane of optimal m and n values and without an A functional group may be used in applications that would require an A functional group for an amphiphilic siloxane without optimal m and n average values. In an embodiment, an amphiphilic siloxane may comprise an m average value of 4, 13, 17, 24, or 30 or an m average value ranging from 3 through 30 and an n average value of 8 or 16 or an n average value ranging from 5 through 16. In certain embodiments, the amphiphilic siloxane may not comprise a silane moiety arranged adjacent to the siloxane tether, the general formula for such an amphiphilic siloxane may be S_{(4, 13, 17, 24, or 30)}P_{(8 or 16)}, for example S₄P₈, S₄P₁₆, S₁₃P₈, S₁₃P₁₆, S₁₇P₈, S₁₇P₁₆, S₂₄P₈, S₂₄P₁₆, S₃₀P₈ or S₃₀P₁₆.

To further illustrate various illustrative embodiments of the present disclosure, the following examples are provided.

### Example 1

Three coatings, labeled “A-C” were formed by blending each of three PEG-silane amphiphiles α-(EtO)₃Si(CH₂)₂-oligodimethylsiloxaneₘ-block-[(CH₂CH₂O)₈—OCH₃; (wherein A had an m of 0; B had an m of 4; and C had an m of 13) with α, ω-bis-(Si—OH)-polydimethylsiloxaneₚ (PDMS) (Mₙ=3000 g/mol) with a 2:3 molar ratio. 3 mol % of H₃PO₄ (based on total solid weight of the aforementioned mixtures) was added as a solution of H₃PO₄/ethanol (10:90 w/w). The mixture was rapidly stirred for 3 hours. 1 mL of each mixture was applied to a microscope slide and cured under vacuum (36 in. Hg) at 180° C. for 48 hours. The silicone “control” was Silastic T-2. It was applied to microscope slides with a drawdown bar (30 mil) and cured at room temperature for 72 hours. Each slide (3 slides per coating composition) was exposed to 20 mL of P. aeruginosa bacteria (10⁸ cells/mL) for 6 hour and the percent coverage by bacteria measured with confocal laser scanning microscopy (CLSM). The results of this test are set forth in Table 1 below.

TABLE 1

| Percent | | | | |
|---|---|---|---|---|
| Coverage | Control | A | B | C |
| 6 hours | 4.4 ± 2.0 | 2.1 ± 2.0 | 1.1 ± 0.3 | 0.3 ± 0.2 |

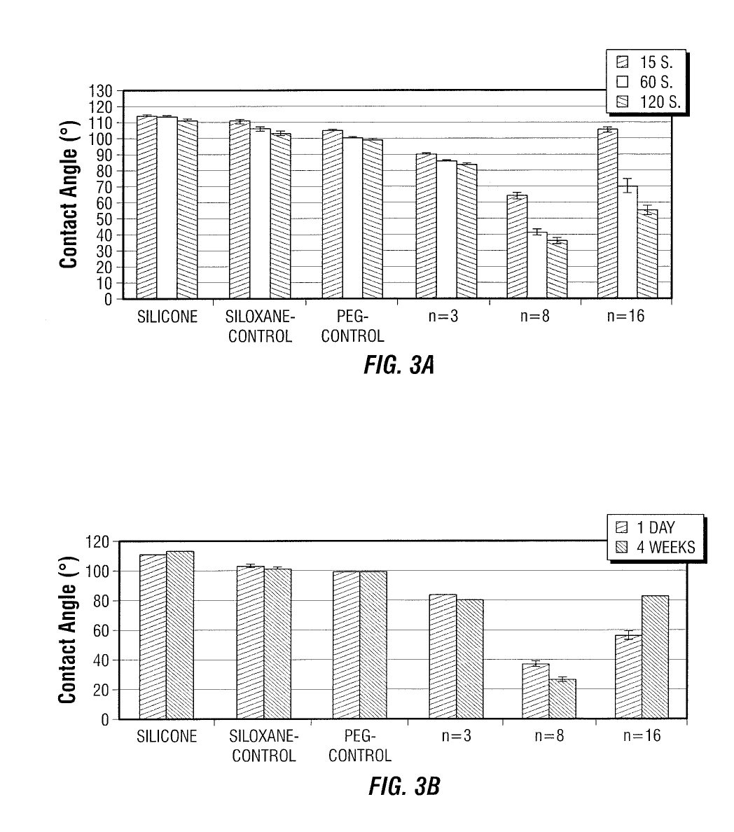

The experiment was repeated except with Cylindrotheca closterium microalgae (3.7×10⁵ cells/mL) instead of bacteria. Adhesion was measured at 1 and 3 weeks. The results of this test are set forth in Table 2 below. Furthermore the slides can be seen in FIGS. 3A and 3B.

TABLE 2

| Percent | | | | |
|---|---|---|---|---|
| Coverage | Control | A | B | C |
| 1 Week | 25.60 ± 5.08 | 26.30 ± 9.30 | 1.30 ± 0.64 | 0.37 ± 1.67 |
| 3 Weeks | 27.80 ± 7.06 | 10.50 ± 1.91 | 7.10 ± 4.26 | 0.73 ± 0.76 |

### Example 2

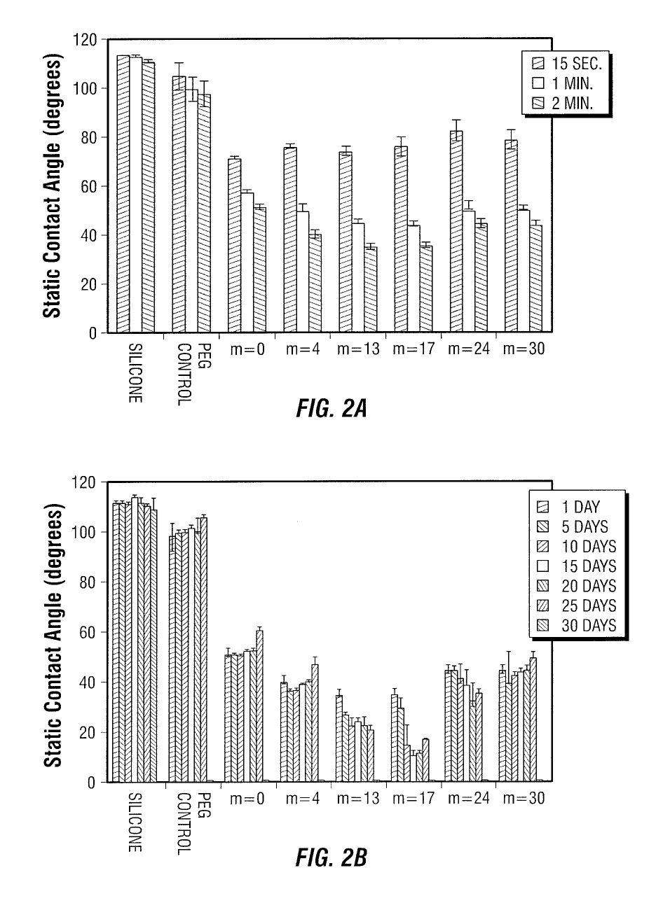

Acetoxy cured RTV silicone, ˜20% reinforcing silica, available as NuSil MED-1137, from NuSil Technology LLC, Carpinteria, Calif. was combined with hexane (1:3, wt:wt). Six PEG-silane amphiphile α-(EtO)₃Si(CH₂)₂-oligodimethylsiloxaneₘ-block-[(CH₂CH₂O)ₙ—OCH₃ samples (m=0, 4, 13, 17, 24, 30 and n=8) and a “PEG-control” [(EtO)₃Si(CH₂)₃—(CH₂—CH₂O)₈—OCH₃)] were each added at a molar concentration of 0.05 mmol per gram of MED-1137. The mixture was then solvent cast (˜33 wt % in hexane) onto glass microscope slides and allowed to cure at room temperature for 7 days. Contact angles (θ_{static}) for water droplets (5 μL) were measured to assess surface hydrophilicity including the water-driven surface reorganization of the PEG to the surface-water interface. The θ_{static} was measured at over a period of 2 minutes (following deposition of the water droplet to the surface). These results may be seen in FIG. 2A. Additionally, the coatings were conditioned in air for 30 days and θ_{static} (measured at 2 minutes following deposition of the water droplet to the surface) were measured. The results of this test may be seen in FIG. 2B.

The results indicate that the hydrophilicity of the resulting modified silicones was impacted by the choice of amphiphilic siloxane; specifically m=13 and 17 were shown to be the most hydrophilic when initially exposed to water (i.e. the water droplet) (FIG. 2A). Notably, the “PEG-control” (i.e. silicone modified with PEG-control) exhibited very little enhanced hydrophilicity. Additionally, for the silicones modified with amphiphilic siloxanes, the surface hydrophilicity was stable during prolonged exposure to air (30 days) (FIG. 2B). Notably, the “PEG-control” (i.e. silicone modified with the PEG-control) remained the most hydrophobic of the modified silicones.

### Example 3

NuSil MED-1137 was combined with hexane (1:3, wt:wt). Three amphiphilic siloxanes α-(EtO)₃Si(CH₂)₂-oligodimethylsiloxane₁₃-block-[(CH₂CH₂O)ₙ—OCH₃ (n=3, 8 and 16), a “PEG-control” [(EtO)₃Si(CH₂)₃—(CH₂—CH₂O)₈—OCH₃)] or “siloxane-control” [(EtO)₃Si(CH₂)₃-oligodimethylsiloxane₁₃-Si—H] were added at a molar concentration of 0.05 mmol per gram of MED-1137. The mixture was then solvent cast (˜33 wt % in hexane) onto glass microscope slides and allowed to cure at room temperature for 7 days. Contact angles (θ_{static}) for water droplets (5 μL) were measured to assess surface hydrophilicity including the water-driven surface reorganization of the PEG to the surface-water interface. The θ_{static} was measured at over a period of 2 minutes (following deposition of the water droplet to the surface). These results may be seen in FIG. 3A. Additionally, the coatings were conditioned in air for 30 days and θ_{static} (measured at 2 minutes following deposition of the water droplet to the surface) at intermediate intervals. The results of this test may be seen in FIG. 3B.

The hydrophilicity of the resulting modified silicones was impacted by choice of amphiphilic siloxane, PEG-control or siloxane-control (FIG. 3A). As expected, the “siloxane-control” (i.e. silicone modified with the siloxane-control) did not increase surface hydrophilicity versus the unmodified silicone (“silicone”). Notably, the “PEG-control” (i.e. silicone modified with PEG-control) exhibited very little enhanced hydrophilicity versus the unmodified silicone (“silicone”). Silicones modified with amphiphilic siloxanes exhibited fast restructuring to the water interface (i.e. θ_{static} at 15 sec was higher than the θ_{static} at 120 sec). Based on the θ_{static} measurement at 120 sec, the most hydrophilic surface is based on the amphiphilic siloxane (n=8). Additionally, the surface hydrophilicity of the coatings was determined after prolonged exposure to air for 4 weeks (FIG. 3B). As expected, the hydrophobicity of “siloxane-control” (i.e. silicone modified with the siloxane-control) did not change. This was also the case for the “PEG-control” (i.e. silicone modified with the PEG-control). For silicones modified with amphiphilic siloxanes (n=3 and 8), the surfaces remained hydrophilic. For the silicones modified with amphiphilic siloxane (n=16), the surface became less hydrophilic but was not as hydrophobic as the silicone modified with the “PEG-control.”

### Example 4

NuSil MED-1137 was combined with hexane (1:3, wt:wt). Eight amphiphilic siloxanes α-(EtO)₃Si(CH₂)₂-oligodimethylsiloxaneₘ-block-[(CH₂CH₂O)ₙ—OCH₃ (A1-A5) and three “PEG-controls” [(EtO)₃Si(CH₂)₃—(CH₂—CH₂O)ₙ—OCH₃)] were added at a molar concentration of 0.05 mmol per gram of MED-1137. The mixture was then solvent cast (˜33 wt % in hexane) onto glass microscope slides and allowed to cure at room temperature for 7 days. Control AS was an unmodifiedsilicone coating (Silastic T2). Sample 700 was INTERSLEEK® 700, a commercial silicone elastomer-based fouling-release coating. INTERSLEEK® is a registered trademark of AkzoNobel. Sample 900 was INTERSLEEK® 900, a commercial, fouling-release coating. Sample 1100SR was INTERSLEEK® 1100SR, a commercial, fouling-release coating. Sample PU was a polyurethane coating. Pre-leach was performed for 7 days and then the microscope slides were subjected to barnacle attachment and adhesion tests. The values for m and n are illustrated in Table 3 below:

TABLE 3

| Sample Number | Siloxane Tether Value (m) | Polymer Value (n) |
|---|---|---|
| A1 | 0 | 8 |
| A2 | 4 | 8 |
| A3 | 13 | 8 |
| A4 | 13 | 3 |
| A5 | 13 | 16 |
| A6 | none | 3 |
| A7 | none | 8 |
| A8 | none | 16 |

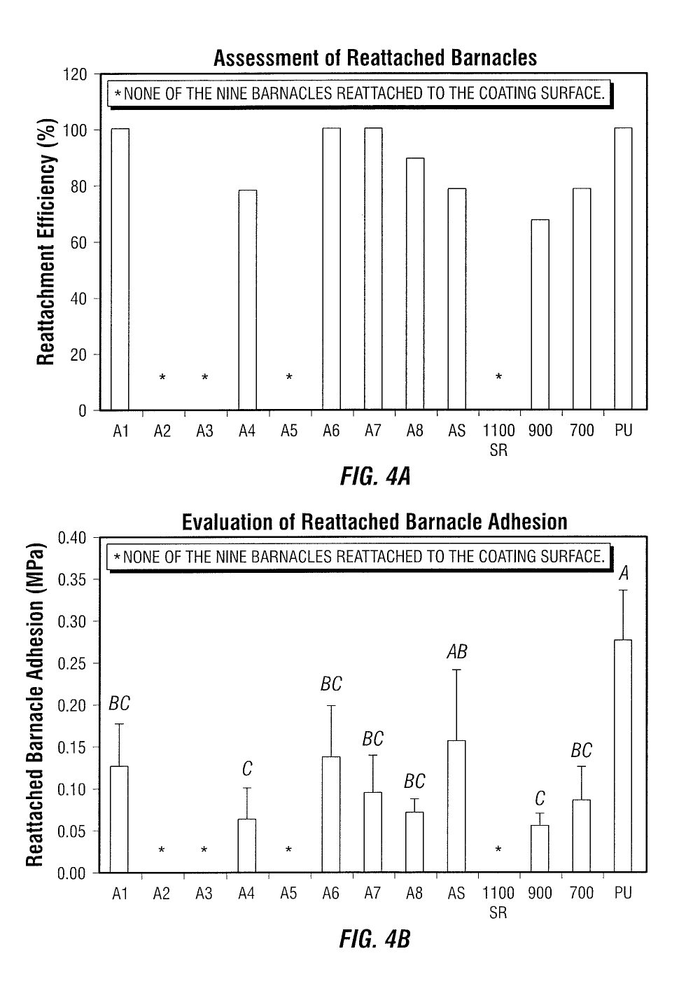

Barnacles (A. Amphitrite) were grown to a certain size and dislodged from a common substrate. Over 2 weeks, nine barnacles were allowed to re-attach onto the various coatings. The number of barnacles able to reattach to each coating surface was recorded in terms of % reattachment efficiency. Each data point was the mean value of the total number of barnacles that reattached to the coating surface. For the re-attached barnacles, the peak force of release was measured with a hand held digital force gauge, mounted to an automated stage. The adhesion strength in shear was calculated by dividing the measured force required to remove the barnacle by the basal area and reported in megapascals (MPa). Error bars represent one standard deviation of the mean. The results are illustrated in FIGS. 4A and 4B.

Although the present disclosure and its advantages have been described in detail, it should be understood that various changes, substitutions and alterations may be made herein without departing from the spirit and scope of the disclosure as defined by the appended claims.

What is claimed is:

1. An amphiphilic siloxane comprising:
a siloxane tether; and
polyethylene glycol.

2. The amphiphilic siloxane of claim 1, further comprising a silane moiety on a terminal end of the amphiphilic siloxane, wherein the silane moiety is a silicon atom bound to three functional groups selected from the group consisting of: alkyl, phenyl, vinyl, allyl, alkoxy, acrylate, methacrylate, hydrogen, amine, carboxylic acid, epoxide, and any combinations thereof.

3. The amphiphilic siloxane of claim 2, wherein the silane moiety is cross-linkable.

4. The amphiphilic siloxane of claim 1, wherein the amphiphilic siloxane is added to a silicone composition.

5. The amphiphilic siloxane of claim 1, wherein the average number of siloxane repeat units in the siloxane tether of the amphiphilic siloxane is 3 through 30.

6. The amphiphilic siloxane of claim 1, wherein the average number of poly(ethylene glycol) (PEG) repeat units in the amphiphilic siloxane is 5 through 16.

7. A mixture comprising an amphiphilic siloxane blended with at least one polymer, a combination of polymers, or a polymer blend, wherein the amphiphilic siloxane comprises:
a silane moiety;
a siloxane tether; and
polyethylene glycol.

8. The mixture of claim 7, wherein the silane moiety is a silicon atom bound to three functional groups selected from the group consisting of: alkyl, phenyl, vinyl, allyl, alkoxy, acrylate, methacrylate, hydrogen, amine, carboxylic acid, epoxide, and any combinations thereof.

9. The mixture of claim 7, wherein the silane moiety is cross-linkable.

10. The mixture of claim 7, wherein the silane moiety of the amphiphilic siloxane undergoes covalent bonding to a surface to provide an amphiphilic siloxane covalently bonded coating of the surface, and wherein the surface is selected from the group consisting of: blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ship hulls, submerged structures, tubing, and combinations thereof.

11. The mixture of claim 10, wherein the surface is a hydroxylated surface.

12. The mixture of claim 7, wherein the amphiphilic siloxane is blended with the different polymer, combination of polymers, or polymer blend to form a coating applied to a structure or material or used to form a structure or material, and wherein the structure or material is selected from the group consisting of: blood-contacting intracorporeal devices, blood-contacting extracorporeal devices, tissue-contacting intracorporeal devices, tissue-contacting extracorporeal devices, catheters, stents, mechanical heat components, heart leads, subcutaneously implanted sensors, blood oxygenator pumps, tubing, syringes, blood bags, ship hulls, submerged structures, tubing, and combinations thereof.

13. The mixture of claim 12, wherein the structure or material is formed by extrusion or molding.

14. The mixture of claim 7, wherein the amphiphilic siloxane cross-links with at least one of the different polymer, combination of polymers, or polymer blend.

15. The mixture of claim 7, wherein the amphiphilic siloxane does not crosslink with any different polymer, combination of polymers, or polymer blend.

16. A method comprising coating a surface with an amphiphilic siloxane blended with at least one polymer, a combination of polymers, or a polymer blend, wherein the amphiphilic siloxane comprises:
a siloxane tether; and
polyethylene glycol.

17. The method of claim 15, wherein the amphiphilic siloxane is blended with the different polymer, combination of polymers, or polymer blend to form a coating applied to a structure or material or used to form a structure or material, and wherein the structure or material is selected from the group consisting of: blood-contacting intracorporeal devices, blood-contacting extracorporeal devices, tissue-contacting intracorporeal devices, tissue-contacting extracorporeal devices, catheters, stents, mechanical heat components, heart leads, subcutaneously implanted sensors, blood oxygenator pumps, tubing, syringes, blood bags, ship hulls, submerged structures, tubing, and combinations thereof.

18. The method of claim 17, wherein the structure or material is formed by extrusion or molding.

19. The method of claim 16, wherein the average number of siloxane repeat units in the siloxane tether of the amphiphilic siloxane is 3 through 30.

20. The method of claim 16, wherein the average number of poly(ethylene glycol) repeat units in the amphiphilic siloxane is 5 through 16.
